(19) United States
(12) Patent Application Publication
(10) Pub. No.: US 2003/0084055 A1
(43) Pub. Date: May 1, 2003

(54) Method, apparatus and program for outputting templates

(75) Inventor: Keisuke Tanaka, Kaisei-machi (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/255,093

(22) Filed: Sep. 26, 2002

(30) Foreign Application Priority Data
Sep. 27, 2001 (JP) 298199/2001

(51) Int. Cl. G06F 17/00; G06F 3/00; H04N 5/445; G06F 7/00; G06F 17/30; G06F 13/00

(52) U.S. Cl. 707/100; 725/52; 725/53; 707/3

(57) ABSTRACT

A desired one of templates can be selected easily for generating postcards using the template. Template data sets and an image insertion area quantity database representing the number of image insertion areas in each of the template data sets are stored in a hard disc of an order reception server. The number of image data sets sent from a user terminal is judged and the image insertion area quantity database is referred to. A catalogue image data set is generated in which the templates each having the image insertion areas corresponding to the number of the image data sets are laid out in priority over the other templates, and sent to the user terminal. The user terminal displays a template catalogue image based on the catalogue image data set, and a user selects the desired one of the templates to place an order for the postcards.

### BACKGROUND OF THE INVENTION

1. Field of the Invention

The present invention relates to a template output method and a template output apparatus for outputting a template catalogue image from a template server or the like that stores templates, in order to display the templates on a monitor or the like for generating a composite image with a user image. The present invention also relates to a program embodied on a computer-readable recording medium that causes a computer to execute the template output method.

2. Description of the Related Art

There are known digital photograph service systems for carrying out various kinds of digital photograph services such as storing photographs obtained by users in image servers after digitization thereof, recording the photographs in CD-Rs to be provided to the users, printing images photographed by users with digital cameras, receiving orders for additional prints, and generating picture postcards. As one form of such digital photograph service systems, a printing service system for receiving printing orders via a network such as the Internet has also been proposed.

In such a printing service system, a user accesses an order reception server installed at a service center for receiving orders from users via a network such as the Internet, by using a Web browser or viewer software installed in his/her personal computer. A Web page for placing a printing order regarding image data is then displayed on the personal computer, and the user can carry out selection of an image to be printed, generation of order information, designation of an agency at which printed matter is received, and transfer of image data and the order information to the order reception server, by using the Web page.

The order reception server sends the image data and the order information to a print server installed at a large-scale laboratory or a mini-laboratory that processes the printing order, and printing is carried out therein according to the order information. In this manner, printed matter such as additional prints, picture postcards, and the like are generated.

In this system, picture postcards are generated by inserting user images in templates having various kinds of designs. In the case where a user places a printing order for such picture postcards, the user accesses a template storing server and downloads a template catalogue image to be displayed on his/her personal computer. The user selects a desired one of the templates from the template catalogue image, as well as an image to be inserted in the selected template. The user further inputs his/her name, address, and phone number, in addition to text or the like, and sends the order information including the content of the input to the order reception server. In this manner, the print server can generate a composite image by inserting the image in the template according to the order information, and can print picture postcards based on composite image data representing the composite image.

Meanwhile, a template catalogue image includes all templates stored in a template storing server in some cases. In other cases, only templates before expiration are displayed in a catalogue image according to expiration information added to each of the templates. For templates whose display is restricted by copyright information, the templates may be displayed to specific users only. Furthermore, only templates of a specific category may be included in a template catalogue image as specified by a user, since templates are stored in classification according to categories such as marriage, birth of a child, relocation, and summer greeting, for example.

However, if the number of templates included in a template catalogue image is too large, selection of a desired one of the templates becomes time-consuming and troublesome.

### SUMMARY OF THE INVENTION

The present invention has been conceived based on consideration of the above circumstances. An object of the present invention is therefore to display templates in a manner that enable easy selection therefrom.

A first template output method of the present invention comprises the steps of:

receiving an input of image quantity information representing the number of images to be inserted in a template;

generating a template catalogue image wherein qualified templates, each of which has the number of image insertion areas agreeing with the number of images to be inserted, are laid out in priority over templates other than the qualified templates, based on all the templates, image insertion area quantity information stored in storage means and representing the number of image insertion areas in each of the templates, and the image quantity information; and

outputting the template catalogue image to an external apparatus.

The external apparatus refers to a personal computer owned by a user for placing a printing order regarding a picture postcard generated from one of the templates and an image or images inserted therein, or an order reception server in the case where an instruction for template catalogue image acquisition is input from the order reception server.

In order to display the qualified templates each having the image insertion area or areas corresponding to the number of images to be inserted in priority over the other templates, various methods can be adopted. For example, the qualified templates maybe displayed first in the template catalogue image, or in colored frames. Alternatively, the qualified templates may be displayed in a larger size than the other templates, or only the qualified templates may be displayed.

In the first template output method of the present invention, in the case where the storage means stores category information regarding categories of the templates, an input representing one of the categories may be received. In this case, the template catalogue image is generated only from the templates corresponding to the input category among all the templates, based on the category information and the input category.

A second template output method of the present invention comprises the steps of:

receiving an input of text information representing text to be inserted in a template;

generating a template catalogue image in which qualified templates related to a keyword corresponding to the text are laid out in priority over templates other than the qualified templates, based on all the templates, keyword information stored in storage means and representing the keyword and/or another keyword related to the templates, and the text information; and

outputting the template catalogue image to an external apparatus.

In the second template output method of the present invention, the qualified templates related to more of the keywords corresponding to the text may be displayed in higher priority in the template catalogue image.

In the second template output method of the present invention, in the case where the storage means stores category information regarding categories of the templates, an input representing one of the categories may be received. In this case, the template catalogue image is generated only from the templates corresponding to the input category among all the templates, based on the category information and the input category.

A first template output apparatus of the present invention comprises:

storage means for storing templates and image insertion area quantity information regarding the number of image insertion areas in each of the templates;

reception means for receiving an input of image quantity information representing the number of images to be inserted in any one of the templates;

generation means for generating a template catalogue image wherein qualified members of the templates, each of which has the number of image insertion areas corresponding to the number of images to be inserted, are laid out in priority over the remainder of the templates, based on the image quantity information and the image insertion area quantity information; and

output means for outputting the template catalogue image to an external apparatus.

In the first template output apparatus of the present invention, in the case where the storage means stores category information regarding categories of the templates, the reception means may receive an input representing one of the categories. In this case, the generation means generates the template catalogue image only from the templates corresponding to the input category among all the templates, based on the category information and the input category.

A second template output apparatus of the present invention comprises:

storage means for storing templates and keyword information representing keywords related to the templates;

reception means for receiving an input of text information representing text to be inserted in any one of the templates;

generation means for generating a template catalogue image wherein qualified members of the templates, each of which is related to one or more of the keywords corresponding to the text to be inserted, are laid out in priority over the remainder of the templates, based on the text information and the keyword information; and

output means for outputting the template catalogue image to an external apparatus.

In the second template output apparatus of the present invention, the generation means may lay out the qualified members of the templates related to more of the keywords corresponding to the text in higher priority in the template catalogue image.

In the second template output apparatus of the present invention, in the case where the storage means stores category information regarding categories of the templates, the reception means may receive an input representing one of the categories. In this case, the generation means generates the template catalogue image only from the templates corresponding to the input category among all the templates, based on the category information and the input category.

The first and second template output methods of the present invention may be provided as programs that cause a computer to execute the template output methods.

According to the first template output method and the first template output apparatus of the present invention, when the input of the image quantity information representing the number of images to be inserted is received, the template catalogue image is generated in which the qualified templates each having the image insertion area or areas corresponding to the number of images to be inserted are laid out in priority over the other templates, based on the image quantity information and the image insertion area quantity information stored in the storage means. The template catalogue image is then output to the external apparatus. In this manner, the external apparatus can display the template catalogue image in which the qualified templates are laid out in priority over the other templates.

In the case where the number of images used for insertion has been determined, it is often the case that only the templates having the exact number of image insertion areas corresponding to the number of images are used. Therefore, by displaying the template catalogue image in which the qualified templates are laid out in priority over the other templates, selection of one of the templates, that has the image insertion area or areas corresponding to the number of images, can be carried out easily.

By outputting the template catalogue image generated from the templates belonging to the category that has been input, the external apparatus can display the template catalogue image in which the qualified templates belonging to the category are laid out in priority over the other templates also belonging to the category. Therefore, by narrowing down the templates to be displayed in the above manner, selection of one of the templates, that has the image insertion area or areas corresponding to the number of images, can be carried out more easily.

According to the second template output method and the second template output apparatus of the present invention, when the input of the text information representing the text used for insertion is received, the template catalogue image is generated in which the qualified templates related to one or more of the keywords corresponding to the text are laid out in priority over the other templates, based on the text information and the keyword information stored in the storage means. The template catalogue image is then output to the external apparatus, and the external apparatus can display the template catalogue image in which the qualified templates are laid out in priority over the other templates.

The text used for insertion corresponds to the type of postcard that a user is going to generate. For example, if a user wishes to generate postcards for marriage announcement, text such as “We Got Married” is inserted. In the case of relocation, text such as “We Moved Out” is inserted. Since the templates are related to the keywords such as “marriage” and “relocation”, the templates appropriate for the postcards that the user is going to generate are laid out in priority in the template catalogue image displayed on the external apparatus. Therefore, the user can easily select one of the templates of a desired type.

In this case, by displaying the template catalogue image in which the templates related to more of the keywords corresponding to the text are displayed in higher priority, the templates that are more appropriate for the postcards to be generated are displayed in higher priority in the template catalogue image. Therefore, the user can easily select one of the templates of a desired type.

By outputting the template catalogue image generated from the templates belonging to the category that has been input, the external apparatus can display the template catalogue image in which the qualified templates belonging to the category are laid out in priority over the other templates also belonging to the category. Therefore, selection of a desired one of the templates can become easier.

### BRIEF DESCRIPTION OF THE DRAWINGS

FIG. 1 is a block diagram showing a configuration of a printing service system adopting a template output apparatus of a first embodiment of the present invention;

FIG. 2 shows the content of an image insertion area quantity database;

FIG. 3 is a flow chart showing the operation of the first embodiment;

FIG. 4 shows an example of a template catalogue image in the first embodiment;

FIG. 5 shows the content of a keyword database;

FIG. 6 is a flow chart showing the operation of a second embodiment; and

FIG. 7 shows an example of a template catalogue image in the second embodiment.

### DESCRIPTION OF THE PREFERRED EMBODIMENTS

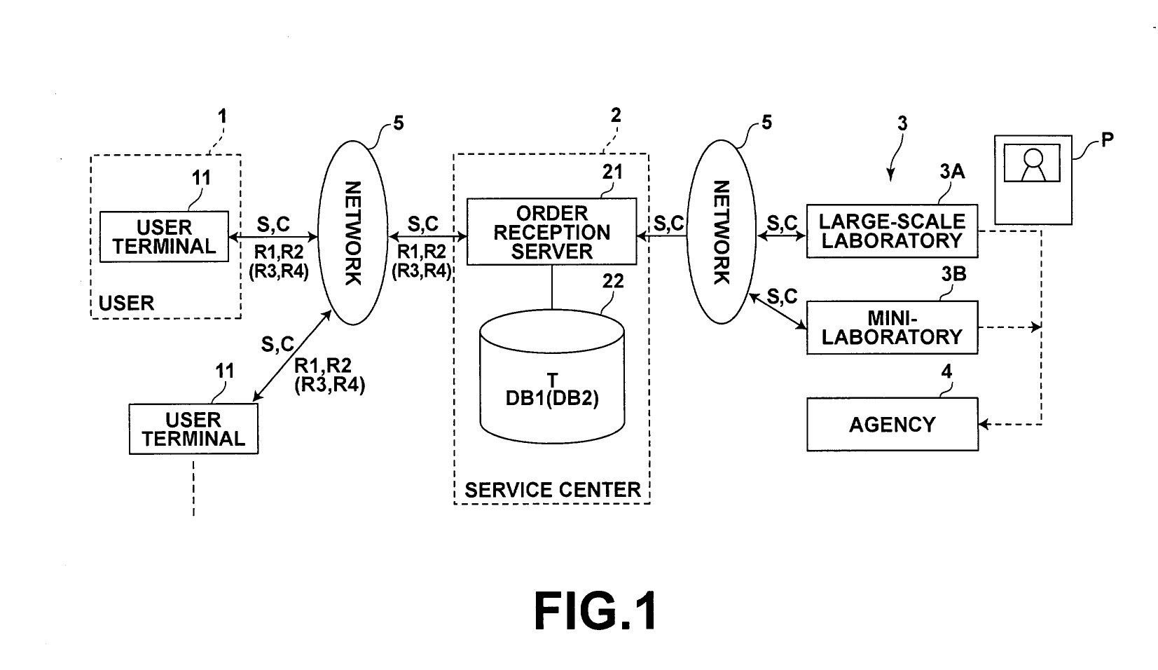

Hereinafter, embodiments of the present invention will be explained with reference to the accompanying drawings. FIG. 1 is a block diagram showing a configuration of a printing service system adopting a template output apparatus of a first embodiment of the present invention. As shown in FIG. 1, the printing service system in the first embodiment exchanges data, prints, and the like between a user 1, a service center 2, printing service providers 3, and an agency 4. In FIG. 1, solid lines show a flow of data while broken lines show a flow of an object.

The user 1 has a personal computer acting as a user terminal 11 that comprises a hard disc, a display, a keyboard, a mouse, a CD-ROM drive, and a PC card slot for reading image data from a recording medium for a digital camera (such as Smart Media and Compact Flash [Registered Trademark]). The user 1 can place a printing order with the service center 2 via a network 5 such as the Internet, as will be explained later. In the case where the user 1 does not have a personal computer, the user 1 can place a printing order by using a terminal dedicated to placing orders and installed at a printing service station such as a DPE store or the like.

The user 1 can view and manipulate image data sets S, generate order information C representing the content of a printing order regarding one or more of the image data sets S (hereinafter referred to as the image data sets S that are in the plural form of the noun, for the sake of simpler explanation), and place the printing order by using viewer software that is installed in the user terminal 11 and has an ordering function. When the user 1 places the printing order, the user terminal 11 accesses the service center 2 by using a function of the viewer software, and the order information C and the image data sets S to be printed are sent to the service center 2. The user 1 can place the printing order by using a Web browser, instead of the viewer software. In this embodiment, the printing order is placed for generating postcards comprising a template and an image or images inserted in the template.

The service center 2 comprises an order reception server 21 for receiving printing orders. The order reception server 21 is always connected to the network 5, and can receive the order information C and the image data sets S from the user terminal 11. The order reception server 21 comprises a hard disc 22 that stores a plurality of template data sets T used for postcard generation and an image insertion area quantity database DB1 regarding the number of image insertion areas in each of templates represented by the template data sets T.

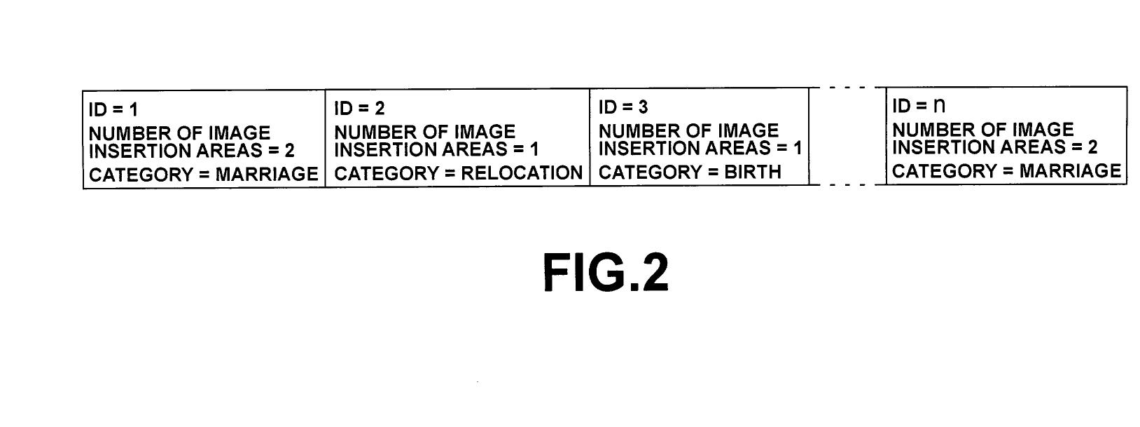

FIG. 2 shows the content of the image insertion area quantity database DB1. As shown in FIG. 2, the image insertion area quantity database DB1 relates the ID of each of the template data sets T to the number of image insertion areas therein and to one of template categories. For example, the template represented by the template data set T whose ID is 1 has two image insertion areas and belongs to a category “marriage”.

The order reception server 21 refers to the image insertion area quantity database DB1 according to the number of the image data sets S sent from the user terminal 11 when the printing order is placed. The order reception server 21 generates a catalogue image data set R1 representing a template catalogue image in which qualified members of the template data sets (hereinafter referred to as template data sets TP) each having the image insertion areas corresponding to the number of the image data sets S are laid out in priority over the rest of the template data sets (hereinafter referred to as template data sets TE), and sends the catalogue image data set R1 to the user terminal 11. In the case where an input for specifying one of the template categories is received from the user terminal 11, the order reception server 21 refers to the image insertion area quantity database DB1, and selects the template data sets corresponding to the specified category from all the template data sets T. The order reception server 21 then generates a catalogue image data set R2 representing a template catalogue image in which the template data sets TP each having the image insertion areas corresponding to the number of the image data sets S are laid out in priority over the other template data sets TE, from the template data sets T that have been selected according to the specified category.

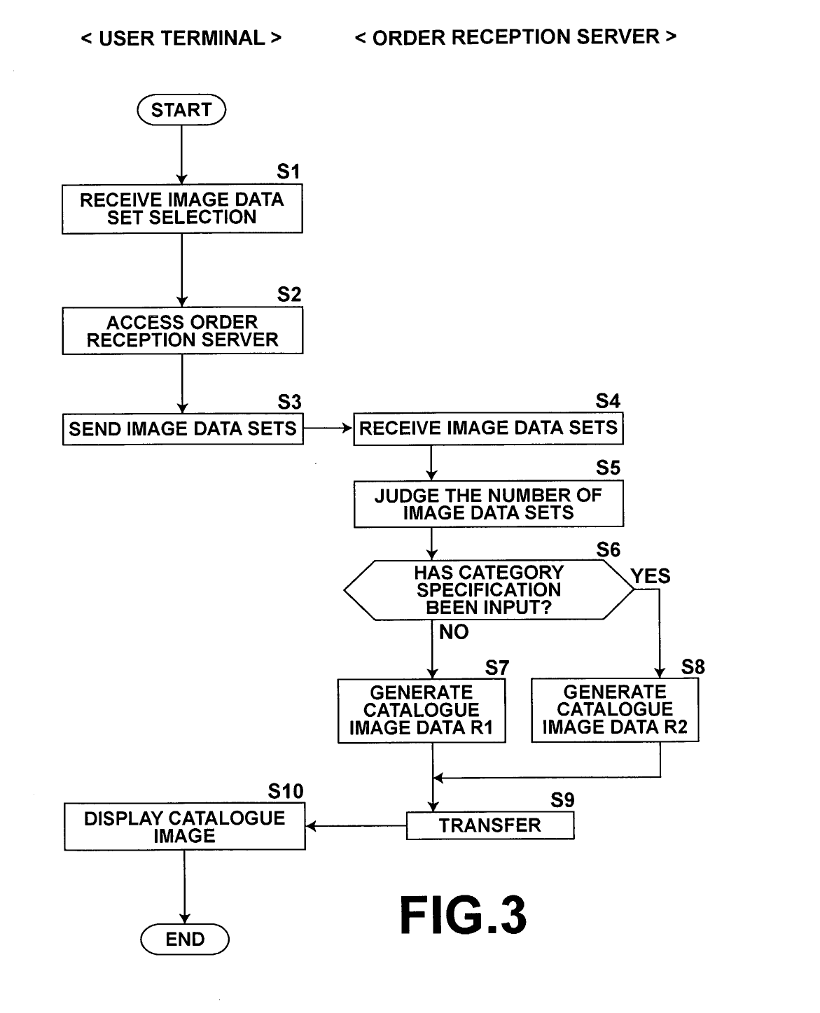

The operation of the first embodiment will be explained next. FIG. 3 is a flow chart showing the operation of the first embodiment. In the user terminal 11, the viewer software accepts selection of the image data sets S to be used for postcard generation from all the image data sets S owned by the user 1 (Step S1). After the selection of the image data sets S, the user terminal 11 accesses the order reception server 21 (Step S2), and the selected image data sets S are sent to the order reception server 21 (Step S3).

The order reception server 21 receives the image data sets S sent from the user terminal 11 (Step S4), and judges the number of the image data sets S (Step S5). Furthermore, the order reception server further judges whether the input of template category specification has been received (Step S6). If a result at Step S6 is negative, the image insertion area quantity database DB1 is referred to, and the catalogue image data sets Set R1 representing the template catalogue image is generated in which the template data sets TP each having the image insertion areas corresponding to the number of the image data sets S are laid out in priority over the other templates TE (Step S7).

Meanwhile, if the result at Step S6 is affirmative, the image insertion area quantity database DB1 is referred to, and the template data sets T corresponding to the template category are selected. The catalogue image data set R2 representing the template catalogue image is generated in which the template data sets TP each having the image insertion areas corresponding to the number of the image data sets S are laid out in priority over the other template data sets TE, from the selected template data sets T (Step S8).

The catalogue image data set R1 or R2 is then sent to the user terminal 11 (Step S9), and displayed on the user terminal 11 (Step S10) to end the procedure. The images represented by the image data sets S may be inserted in the image insertion areas of each of the templates in the catalogue image data set R1 or R2.

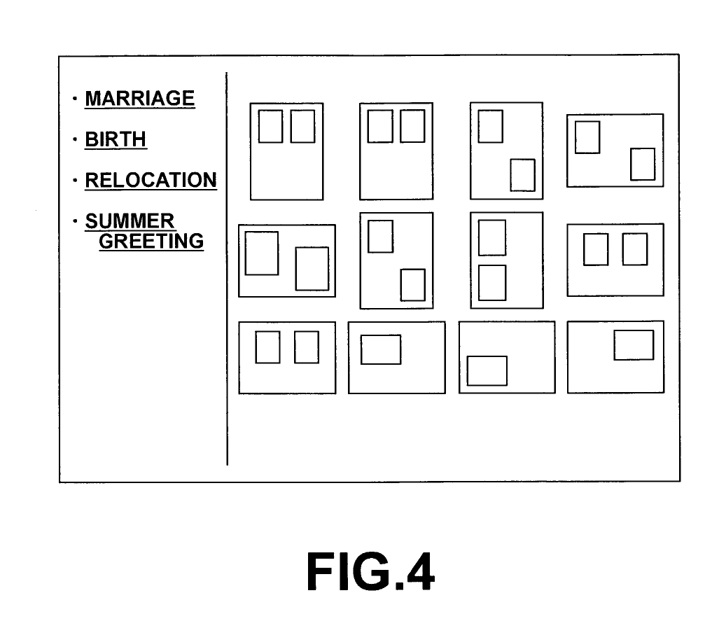

FIG. 4 shows the template catalogue image displayed on the user terminal 11. In this example, the number of the image data sets S used for postcard generation is two. The difference between the catalogue image data sets R1 and R2 is only the specification of the template category. Therefore, only the template catalogue image without template category specification is shown in FIG. 4, based on the catalogue image data set R1.

As shown in FIG. 4, in the template catalogue image, the templates TP each having two image insertion areas are displayed from the upper left corner of the screen. In the left of the template catalogue image are shown buttons for selecting one of the template categories, such as “marriage”, “birth”, “relocation” and “summer greeting”. These buttons are shown from the top in descending order of categories in which the number of the template data sets TP having the image insertion areas corresponding to the number of the image data sets S sent by the user is larger. If the number of the template data sets TP is the same between any two or more of the categories, the template data sets T are shown in the template catalogue image in predetermined order of categories (such as the date of generation thereof).

When the user 1 clicks one of the buttons corresponding to the category he/she desires, information representing the selected category is sent to the order reception server 21, and the catalogue image data set R2 is generated regarding the selected category in the same procedure as at Step S8. The catalogue image data set R2 is then sent to the user terminal 11, and displayed thereon.

The user 1 selects one of the templates displayed in the template catalogue image on the user terminal 11, and inputs his/her name, address and phone number, text to be inserted, a quantity of postcards, and an agency at which the postcards are to be received. In this manner, the order information C representing the content of the printing order is generated and sent to the order reception server 21.

The order reception server 21 receives the order information C sent from the user terminal 11, and selects one of the printing service providers 3 such as a large-scale laboratory 3A in collaboration with the agency designated by the user 1 when the printing order was placed, or a mini-laboratory 3B functioning as an agency as well, for carrying out printing according to the order information C. The order reception server 21 then sends the order information C and the image data sets S to the selected printing service provider 3.

In the printing service provider 3, the image data sets S and the order information C are received, and postcards P are generated according to the order information C. The postcards P are delivered or mailed to the agency 4 designated by the user 1 (to the mini-laboratory 3B in the case where the mini-laboratory 3B has been designated) when the user 1 places the printing order. The user 1 visits the agency 4 and receives the postcards P.

As has been described above, in the first embodiment, the template catalogue image is displayed on the user terminal 11 in which the templates TP each having the image insertion areas corresponding to the number of the image data sets S sent by the user 1 are laid out in priority over the other templates TE. In the case where the number of the image data sets S to be inserted has been determined, it is often the case that only the templates having the image insertion areas corresponding to the number of the image data sets S are used. For this reason, by displaying the template catalogue image as in the first embodiment, the user 1 can easily select one of the templates having the image insertion areas corresponding to the number of images to be used for generation of the postcards P.

By generating the template catalogue image from the templates belonging to the category that has been input, the template catalogue image is displayed on the user terminal 11 in which the template data sets each having the image insertion areas corresponding to the number of the image data sets S sent by the user 1 are laid out in priority over the other templates, based on the template data sets belonging to the specified category. Therefore, the user 1 can narrow down the template data sets T and can more easily select the desired template whose number of image insertion areas agrees with the number of images to be inserted.

In the above embodiment, the catalogue image data set R1 or R2 is generated by sending the image data sets S first from the user terminal 11. However, the catalogue image data set maybe generated after only the number of images to be inserted is sent to the order reception server 21. In this case, the image data sets S to be printed are sent to the order reception server 21 together with the order information C.

In the above embodiment, the order reception server 21 generates the catalogue image data set R1 or R2 based on the number of the image data sets S that have been received. However, the present invention is applicable to the case where information representing the number of the image data sets S that have been received by the order reception server 21 is sent to another server that stores the template data sets T. In this case, the catalogue image data set R1 or R2 is generated from the template data sets TP each having the image insertion areas corresponding to the number of the image data sets S, among the template data sets T stored in the server. The catalogue image data set R1 or R2 is then sent from the server to the order reception server 21.

A second embodiment of the present invention will be explained next. In the second embodiment, text to be inserted in a postcard or postcards (hereinafter referred to as the postcards) is input from a user terminal 11 and the processing carried out by an order reception server 21 is different from the processing carried out by the order reception server 21 in the first embodiment. Therefore, only the difference will be explained below.

In the second embodiment, a hard disc 22 of the order reception server 21 stores template data sets T for postcard generation and a keyword database DB2 that stores a keyword or keywords (hereinafter referred to as the keywords) related to each of templates represented by the template data sets T.

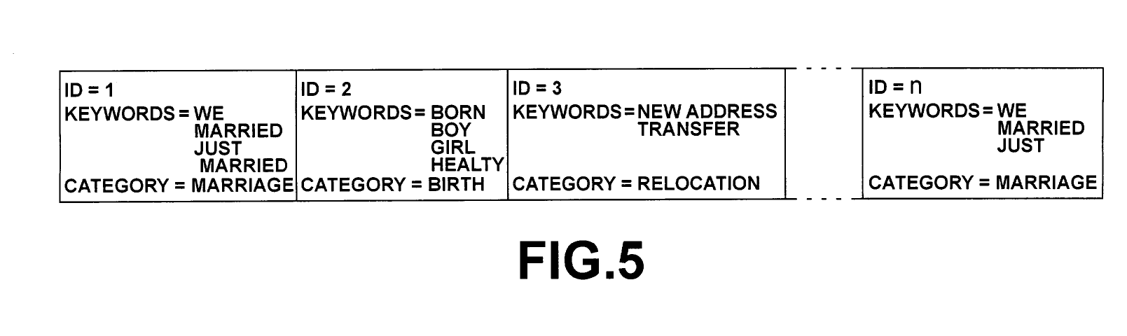

FIG. 5 shows the content of the keyword database DB2. As shown in FIG. 5, the keyword database DB2 relates the ID of each of the template data sets T to the keywords and to one of template categories. For example, the template whose ID is 1 is related to the keywords “we”, “married”, and “just married”, and is related to a category “marriage”.

The order reception server 21 refers to the keyword database DB2, based on the text input from the user terminal 11 when a printing order is placed, and generates a catalogue image data set R3 representing a template catalogue image in which qualified members of the template data sets T related to the keywords corresponding to the text (hereinafter referred to as template data sets TP) are displayed in priority over the rest of the template data sets T (hereinafter referred to as template data sets TE). The catalogue image data set R3 is sent to the user terminal 11. In the case where an input of template category specification has been received from the user terminal 11, the order reception server 21 refers to the keyword database DB2, and selects the template data sets T corresponding to the selected category. The order reception server 21 then generates from the selected template data sets T a catalogue image data set R4 representing a template catalogue image in which the template data sets TP related to the keywords corresponding to the text are laid out in priority over the other templates TE.

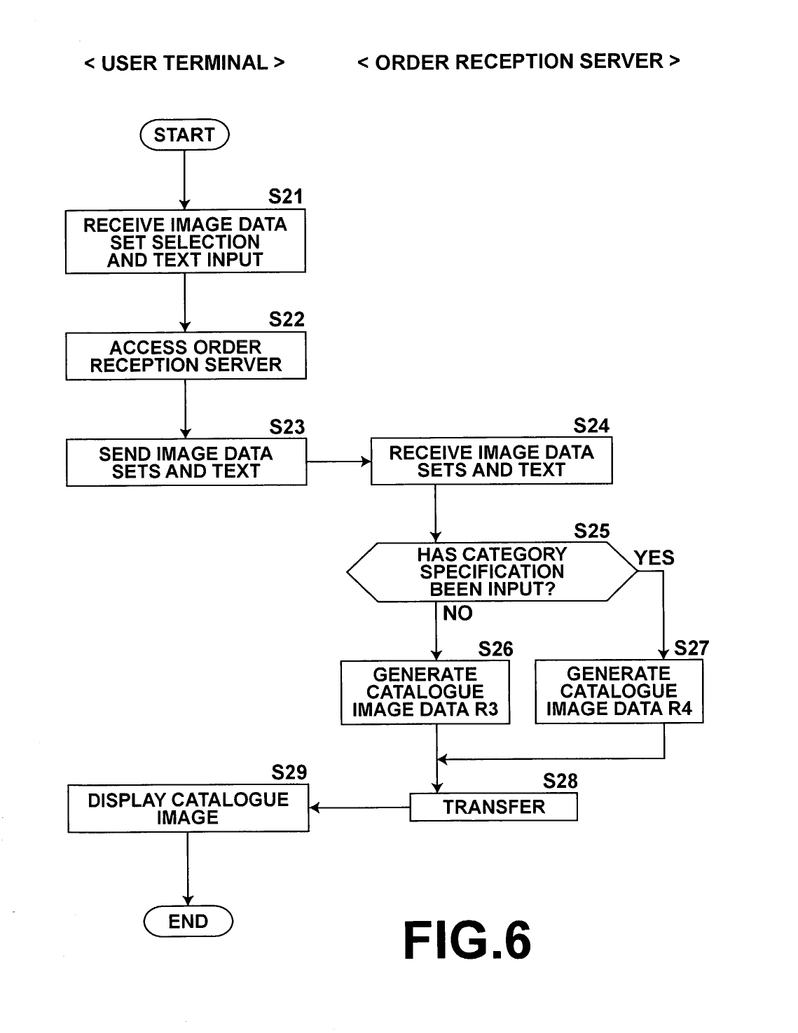

The operation of the second embodiment will be explained next. FIG. 6 is a flow chart showing the operation of the second embodiment. In the user terminal 11, viewer software receives an input of the text to be inserted in the postcards and selection of one or more of image data sets S owned by a user (hereinafter referred to as the image data sets S) to be used for generating the postcards (Step S21). After the selection of the image data sets S and the input of the text, the user terminal 11 accesses the order reception server 21 (Step S22) and the selected image data sets S and the text are sent to the order reception server 21 (Step S23).

In the order reception server 21, the image data sets S and the text are received (Step S24), and whether or not the template category has been specified is then judged (Step S25). If a result at Step S25 is negative, the keyword database DB2 is referred to with reference to the text. The catalogue image data set R3 is then generated for representing the template catalogue image in which the template data sets TP related to the keywords corresponding to the text are shown in priority over the other templates TE (Step S26).

If the result at Step S25 is affirmative, the keyword database DB2 is referred to, and the template data sets T corresponding to the input category are selected. The catalogue image data set R4 is generated from the selected template data sets T for representing the template catalogue image in which the template data sets TP related to the keywords corresponding to the text are shown in priority over the other templates TE (Step S27).

The catalogue image data set R3 or R4 is then sent to the user terminal 11 (Step S28), and displayed on the user terminal 11 (Step S29) to end the procedure. The images represented by the image data sets S may be inserted in each of the templates in the catalogue image data set R3 or R4.

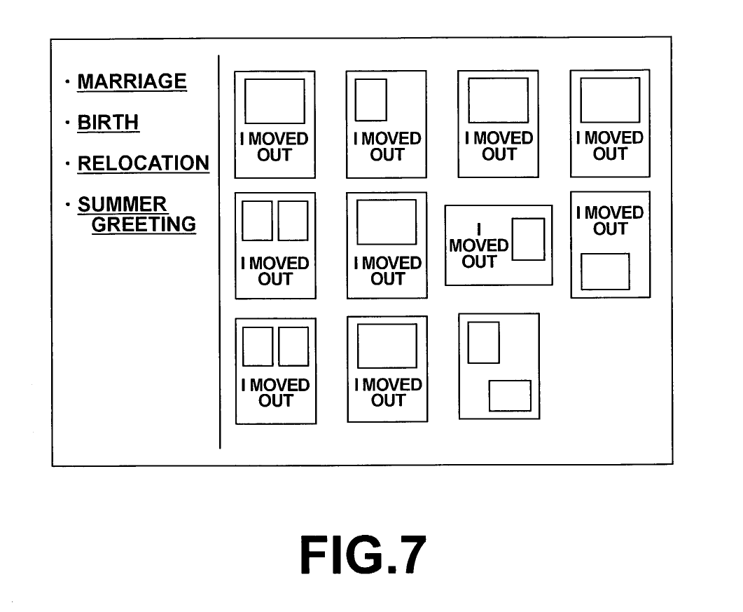

FIG. 7 shows the template catalogue image displayed on the user terminal 11. The text “I moved out upon transfer” has been input in this example. The difference between the catalogue image data set R3 and R4 is whether the category has been specified or not. Therefore, the template catalogue image in FIG. 7 is based on the catalogue image data set R3 whose category has not been specified.

As shown in FIG. 7, in the template catalogue image, the templates related to the keywords “moved” “transfer” are shown from the upper left corner of the screen. In the left of the screen are shown buttons for selecting one of the template categories, such as “marriage”, “birth”, “relocation” and “summer greeting”. The buttons are shown from the top of the screen in descending order of categories including more template data sets TP each having the image insertion areas corresponding to the number of the image data sets S sent by the user. In the case where the number of the image insertion areas is the same between two or more of the categories, the templates are laid out in predetermined order (such as the date of generation thereof) in the template catalogue image.

When the user 1 clicks one of the buttons corresponding to the category he/she desires, information representing the selected category is sent to the order reception server 21, and the catalogue image data set R4 is generated regarding the selected category in the same procedure as at Step S27. The catalogue image data set R4 is then sent to the user terminal 11 and displayed thereon.

The user 1 selects one of the templates displayed in the template catalogue image on the user terminal 11, and inputs his/her name, address and phone number, the text to be inserted, a quantity of postcards, and an agency at which the postcards are received. In this manner, order information C representing the content of the printing order is generated and sent to the order reception server 21.

The order reception server 21 receives the order information C sent from the user terminal 11, and selects one of printing service providers 3 such as a large-scale laboratory 3A in collaboration with the agency designated by the user when the printing order was placed or a mini-laboratory 3B functioning as an agency as well, for carrying out printing according to the order information C. The order reception server 21 then sends the order information C and the image data sets S to the selected printing service provider 3.

In the printing service provider 3, the image data sets S and the order information C are received, and postcards P are generated according to the order information C. The postcards P are delivered or mailed to the agency 4 designated by the user 1 (to the mini-laboratory 3B in the case where the mini-laboratory 3B has been designated) when the user 1 placed the order. The user 1 visits the agency 4 and receives the postcards P.

As has been described above, in the second embodiment, the template catalogue image is displayed on the user terminal 11 in which the template data sets TP related to the keywords corresponding to the text are shown in priority over the other template data sets TE. The text to be inserted corresponds to the type of postcards the user is going to generate. For example, in the case of postcards announcing marriage, the text “we got married” is inserted while the text “I moved out” is inserted in the case of postcards announcing relocation. Meanwhile, the templates are related to the keywords such as “marriage” and “relocation”, and the templates appropriate for the postcards that the user is going to generate are laid out in priority over the other templates in the template catalogue image displayed on the user terminal 11. Therefore, the user can easily select one of the templates of the type he/she desires.

It is preferable for the templates related to more of the keywords corresponding to the text are laid out in higher priority in the template catalogue image. In this manner, the templates appropriate for the postcards that the user is going to generate are laid out in higher priority, and the user can select the desired one of the templates more easily.

By generating the template catalogue image from the templates belonging to the category that has been input, the template catalogue image is displayed on the user terminal 11 in which the templates related to the keywords corresponding to the text are laid out in priority, based on the templates belonging to the category. Therefore, the templates can be narrowed down and the user can select the desired one of the templates more easily.

In the first embodiment, when a new template data set T is stored in the hard disc 22, the number of the image insertion areas in the new template data set is registered with the image insertion area quantity database DB1. In this manner, the new template data set T can be included immediately in the template catalogue image.

In the second embodiment, when a new template data set T is stored in the hard disc 22, the keywords related to the new template data set T are generated and registered with the keyword database DB2. In this manner, the new template data set T can be included immediately in the template catalogue image.

In the first and second embodiments, the template catalogue image is generated by laying out the template data sets TP in priority over the other template data set TE. However, the template catalogue image may be displayed in other methods. For example, the template data sets T are shown in order of generation thereof, and the template data sets TP are shown in colored frames or in a larger size. Alternatively, only the template data sets TP may be displayed in the template catalogue image.

A skilled artisan would know that computer readable media are not limited to any specific type of storage device and include any kind of device, including but not limited to CDs, floppy discs, RAMs, ROMs, hard discs, magnetic tapes, and internet downloads, in which computer instructions can be stored and/or transmitted. Transmission of the computer code through a network or through wireless transmission means is also within the scope of this invention. Additionally, computer code/instructions include, but are not limited to, source, object, and executable code and can be in any language including higher level languages, assembly language and machine language.

What is claimed is:

1. A template output method comprising the steps of:
receiving an input of image quantity information representing the number of images to be inserted in a template;
generating a template catalogue image wherein qualified templates, each of which has the same number of image insertion areas as the number of images to be inserted, are laid out in priority over templates other than the qualified templates, based on all the templates, image insertion area quantity information stored in storage means and representing the number of image insertion areas in each of the templates, and the image quantity information; and
outputting the template catalogue image to an external apparatus.

2. A template output method as defined in claim 1, further comprising the step of:
receiving an input representing one of template categories in the case where the storage means stores category information regarding the template categories of the templates, wherein
the step of generating the template catalogue image is the step of generating the template catalogue image only from the templates corresponding to the input category among all the templates, based on the category information and the input category.

3. A template output method comprising the steps of:
receiving an input of text information representing text to be inserted in a template;
generating a template catalogue image in which qualified templates related to a keyword corresponding to the text are laid out in priority over templates other than the qualified templates, based on all the templates, keyword information stored in storage means and representing the keyword and/or another keyword related to the templates, and the text information; and
outputting the template catalogue image to an external apparatus.

4. A template output method as defined in claim 3, wherein the step of generating the template catalogue image is the step of generating the template catalogue image wherein the qualified templates related to more of the keywords corresponding to the text are displayed in higher priority.

5. A template output method as defined in claim 3 or 4, further comprising the step of:
receiving an input representing one of template categories in the case where the storage means stores category information regarding the template categories of the templates, wherein
the step of generating the template catalogue image is the step of generating the template catalogue image only from the templates corresponding to the input category among all the templates, based on the category information and the input category.

6. A template output apparatus comprising:
storage means for storing templates and image insertion area quantity information regarding the number of image insertion areas in each of the templates;
reception means for receiving an input of image quantity information representing the number of images to be inserted in any one of the templates;
generation means for generating a template catalogue image wherein qualified members of the templates, each of which has the same number of image insertion areas as the number of images to be inserted, are laid out in priority over the remainder of the templates, based on the image quantity information and the image insertion area quantity information; and
output means for outputting the template catalogue image to an external apparatus.

7. A template output apparatus as defined in claim 6, wherein, in the case where the storage means stores category information regarding categories of the templates, the reception means receives an input representing one of the categories, and the generation means generates the template catalogue image only from the templates corresponding to the input category among all the templates, based on the category information and the input category.

8. A template output apparatus comprising:
storage means for storing templates and keyword information representing keywords related to the templates;
reception means for receiving an input of text information representing text to be inserted in any one of the templates;
generation means for generating a template catalogue image wherein qualified members of the templates, each of which is related to one or more of the keywords corresponding to the text to be inserted, are laid out in priority over the remainder of the templates, based on the text information and the keyword information; and
output means for outputting the template catalogue image to an external apparatus.

9. A template output apparatus as defined in claim 8, wherein the generation means lays out the qualified members of the templates that are related more of the keywords corresponding to the text in higher priority in the template catalogue image.

10. A template output apparatus as defined in claim 8 or 9, wherein, in the case where the storage means stores category information regarding categories of the templates, the reception means receives an input representing one of the categories and the generation means generates the template catalogue image only from the templates corresponding to the input category among all the templates, based on the category information and the input category.

11. A program that causes a computer to execute the steps of:
receiving an input of image quantity information representing the number of images to be inserted in a template;
generating a template catalogue image wherein qualified templates, each of which has the same number of image insertion areas as the number of images to be inserted, are laid out in priority over templates other than the qualified templates, based on all the templates, image insertion area quantity information stored in storage means and representing the number of image insertion areas in each of the templates, and the image quantity information; and
outputting the template catalogue image to an external apparatus.

12. A program as defined in claim 11, further comprising the step of:
receiving an input representing one of template categories in the case where the storage means stores category information regarding the template categories of the templates, wherein
the step of generating the template catalogue image is the step of generating the template catalogue image only from the templates corresponding to the input category among all the templates, based on the category information and the input category.

13. A program that causes a computer to execute the steps of:
receiving an input of text information representing text to be inserted in a template;
generating a template catalogue image in which qualified templates related to a keyword corresponding to the text are laid out in priority over templates other than the qualified templates, based on all the templates, keyword information stored in storage means and representing the keyword and/or another keyword related to the templates, and the text information; and
outputting the template catalogue image to an external apparatus.

14. A program as defined in claim 13, wherein the step of generating the template catalogue image is the step of generating the template catalogue image wherein the qualified templates related to more of the keywords corresponding to the text are displayed in higher priority.

15. A program as defined in claim 13 or 14, further comprising the step of:
receiving an input representing one of template categories in the case where the storage means stores category information regarding the template categories of the templates, wherein
the step of generating the template catalogue image is the step of generating the template catalogue image only from the templates corresponding to the input category among all the templates, based on the category information and the input category.

16. A computer-readable recording medium storing a program that causes a computer to execute the steps of:
receiving an input of image quantity information representing the number of images to be inserted in a template;
generating a template catalogue image wherein qualified templates, each of which has the same number of image insertion areas as the number of images to be inserted, are laid out in priority over templates other than the qualified templates, based on all the templates, image insertion area quantity information stored in storage means and representing the number of image insertion areas in each of the templates, and the image quantity information; and
outputting the template catalogue image to an external apparatus.

17. A computer-readable recording medium as defined in claim 16, the program further comprising the step of:
receiving an input representing one of template categories in the case where the storage means stores category information regarding the template categories of the templates, wherein
the step of generating the template catalogue image is the step of generating the template catalogue image only from the templates corresponding to the input category among all the templates, based on the category information and the input category.

18. A computer-readable recording medium storing a program that causes a computer to execute the steps of:
receiving an input of text information representing text to be inserted in a template;
generating a template catalogue image in which qualified templates related to a keyword corresponding to the text are laid out in priority over templates other than the qualified templates, based on all the templates, keyword information stored in storage means and representing the keyword and/or another keyword related to the templates, and the text information; and
outputting the template catalogue image to an external apparatus.

19. A computer-readable recording medium as defined in claim 18, wherein the step of generating the template catalogue image is the step of generating the template catalogue image wherein the qualified templates related to more of the keywords corresponding to the text are displayed in higher priority.

20. A computer-readable recording medium as defined in claim 18 or 19, the program further comprising the step of:
receiving an input representing one of template categories in the case where the storage means stores category information regarding the template categories of the templates, wherein
the step of generating the template catalogue image is the step of generating the template catalogue image only from the templates corresponding to the input category among all the templates, based on the category information and the input category.
